(19) United States
(12) Patent Application Publication
(10) Pub. No.: US 2002/0164229 A1
(43) Pub. Date: Nov. 7, 2002

(54) Method and apparatus for binding a plurality of sheets

(75) Inventor: Harold P. Hocking, Manhattan Beach, CA (US)

Correspondence Address: Irving Keschner, Suite 1150, 21515 Hawthorne Boulevard, Torrance, CA, 90503, US

(73) Assignee: Powis Parker

(21) Appl. No.: 09/849,933

(22) Filed: May 7, 2001

(51) Int. Cl. B42B 2/00; B42C 1/00; B42C 9/00

(52) U.S. Cl. 412/8; 412/6

(57) ABSTRACT

A method for binding together a plurality of paper sheets. The binding process comprises providing a book binding sheet coated on one side with hot-melt adhesive, orienting and securing sheets of paper that will comprise the book to be bound relative to the binding sheet, securing the leading edge of the binding sheet to the front of the book to be bound, severing the secured portion from the remaining binding sheet material, wrapping the binding severed strip around the spine and rear cover and heating the adhesive to produce a permanent bond with the edges of the spine and covers.

### BACKGROUND OF THE INVENTION

1. Field of the Invention

The present invention provides a method and apparatus for binding a plurality of sheets together using a hot-melt adhesive, the adhesive being formed on a continuous roll of binding material. The sheet includes a resistive strip along the tail end of the roll for identifying the physical characteristics of the roll. The resistive strip is also used to indicate to the apparatus when the roll is consumed and needs to be replaced.

2. Description of the Prior Art

Techniques for binding sheets of material, such as paper, in a manner to form books have been widely available in the prior art. For example, U.S. Pat. Nos. 5,829,938 and 6,056,493 to Hartwig et al (the inventor of the present invention is a co-inventor on both the '938 and '493 patents) disclose a specific book binding apparatus using a L-shaped tape. Although the '938 and '493 patents disclose a useful book binding apparatus, the apparatus is relatively expensive to fabricate due to the number of mechanical components required. In addition, separate L-shaped binding tapes are utilized to bind sheets together.

U.S. Pat. No. 4,898,506 to Lázár discloses a bonding system for securing a hot-melt strip material to an overlying sheet material and a grooving system for grooving the sheet material adjacent the opposite side edges of the strip material after it has been secured to the sheet. This patent is directed to a method and apparatus for producing the binding strips themselves, not a method for applying binding strips to sheets of paper. In addition, the above noted prior art patents do not disclose a technique wherein the binding material itself indicates to the processing apparatus, the physical characteristics thereof or, in the case of the Lázár patent, an indication when the roll is at the tail end.

What is thus desired is to provide an improved method and apparatus for binding together a plurality of sheets and wherein the binding material roll includes means for indicating to the binding apparatus the physical characteristics of the material and when a replacement roll is required.

### SUMMARY OF THE PRESENT INVENTION

The present invention provides a method and apparatus for binding together a plurality of paper sheets. The binding process comprises providing a roll of book binding material coated on one side with hot-melt adhesive, orienting and securing sheets of paper, rear cover and spine that will comprise the book to be bound relative to the binding material, securing the leading edge of the binding material to the front of the book to be bound, severing the secured portion from the remaining binding material, wrapping the binding severed strip around the spine and rear cover and heating the adhesive to produce a permanent bond with the edges of the spine and covers. The binding material includes a strip of resistive material formed near the tail end of the roll to identify its physical characteristics to the microprocessor utilized in the apparatus. In addition to providing identification of the physical characteristics (this information is always available whenever the machine is turned on regardless of the amount of material consumed previously), the resistive strip applied to the binding material is physically wrapped around the core of the roll in such a way that when the material on the roll is consumed, the resistive strip becomes disconnected from the conductive edges of the core thus indicating to the microprocessor that the roll should be replaced to prevent partial or incomplete binding of the last document.

The present invention thus provides an improved book binding apparatus that is more automated and faster than prior art book binding machines.

### BRIEF DESCRIPTION OF THE DRAWINGS

For a better understanding of the present invention as well as other objects and further features thereof, reference is made to the following description which is to be read in conjunction with the accompanying drawing therein:

FIG. 1 is a simplified partial exploded perspective view of the book binding apparatus of the present invention;

FIGS. 2-7 illustrate the steps for binding a plurality of paper sheets together to form a book; and

FIG. 8 illustrates the novel binding material roll of the present invention.

### DESCRIPTION OF THE INVENTION

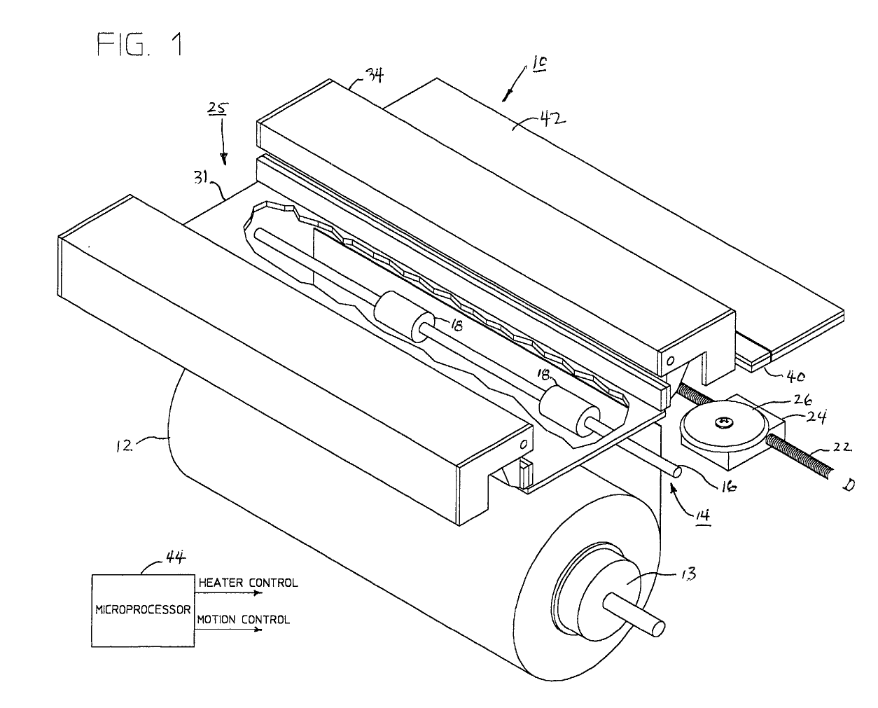

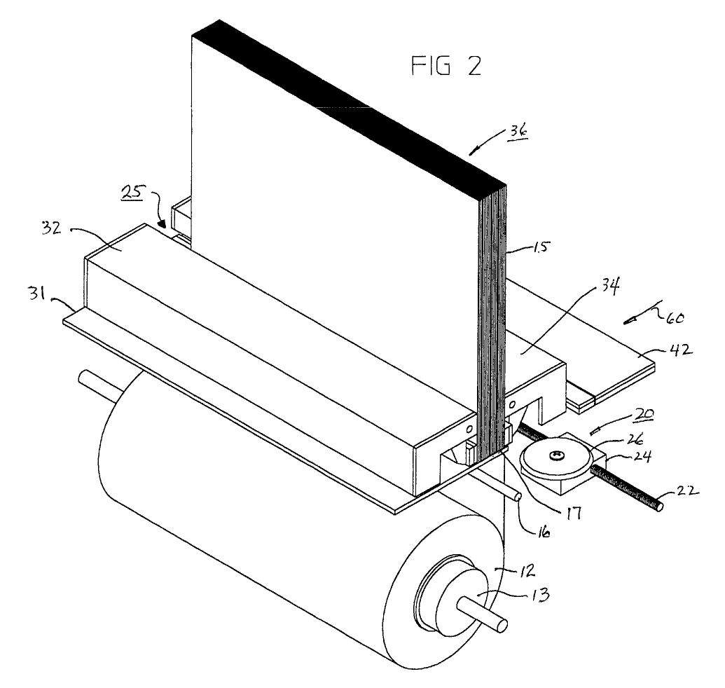

Referring now to FIGS. 1 and 2, the book binding apparatus 10 of the present invention is illustrated.

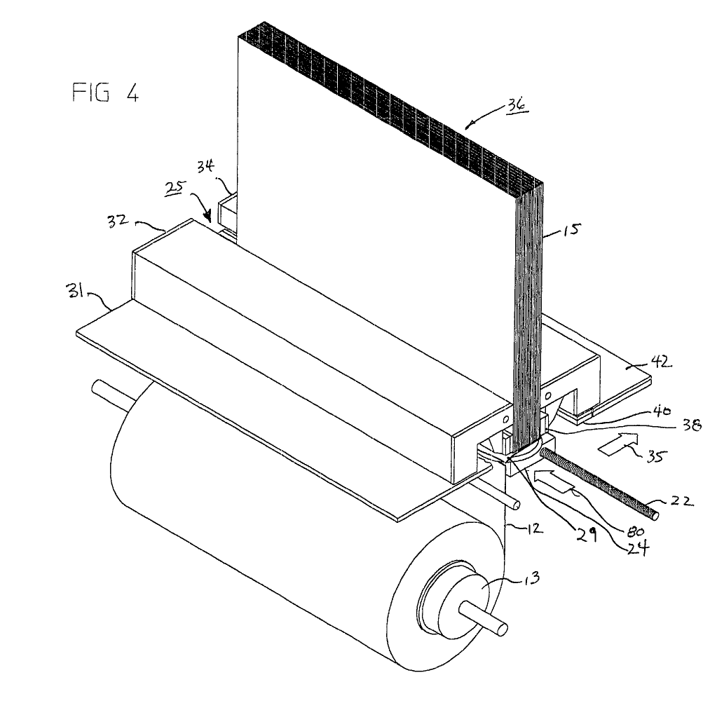

Binding material roll 12 comprises a conventional continuous length binding sheet coated with hot-melt glue adhesive formed on one surface wound on spindle 13. Roll 12 is selected to be the width of the pages to be bound together avoiding the need to be cut or trimmed along the width dimension. A tape feed roller system 14 comprising driver shaft 16 and rollers 18 advances the binding material roll 12 in discrete increments in order to position the binding material precisely along the lower edge of the front cover of the block of pages 36 to be bound. Cutter 20, comprising leadscrew 22, carriage, or carrier 24 for the cutter blade,and rotating cutter blade 26, is positioned to sever a precise length from the binding material roll 12 necessary to wrap around the book spine 27, the length of the cut strip portion being dependent on the number and thickness of the sheets presented into the binding cavity 25 for binding. Cutter 20 is advanced by rotating the lead screw 22 across the entire width of the binding material 12, severing a binding strip 29 (FIG. 4) from the rest of the roll 12. A paper shelf 31 is located at the bottom of binding cavily 25 and provides a flat smooth plenum surface along which the pages to be bound are accumulated and aligned prior to binding. The binding cavity 25 supports the sheets while they are accumulated prior to binding and is surrounded by perpendicular surfaces used to align the edges of the sheets as will be set forth hereinafter.

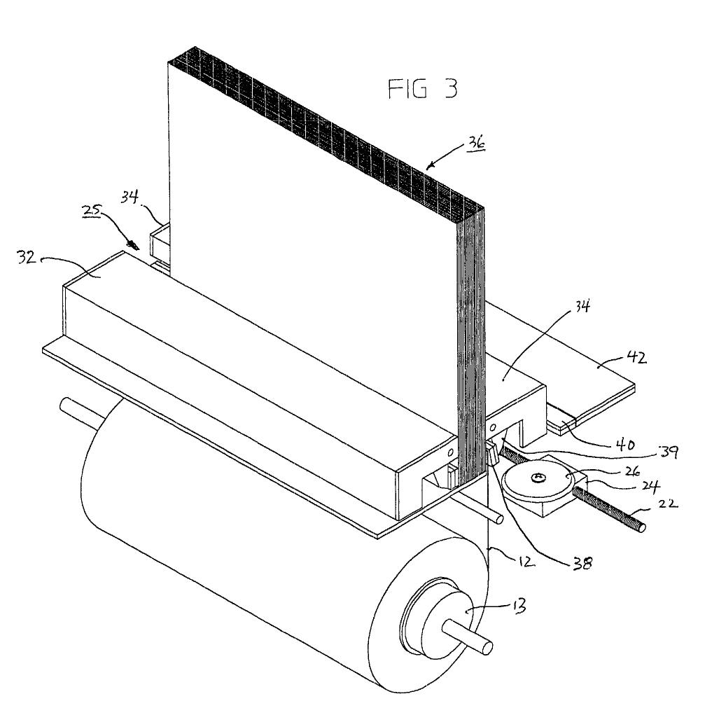

The opening of binding cavity 25 is flanked on two sides by clamps 32 and 34, the clamps securing the sheets after the edges are aligned to maintain the alignment during the binding process. Clamps 32 and 34 are adjacent the lower edge of the block of pages 36 to be bound to secure the block as well as the corners. The lower edges of clamps 32 and 34 are mounted in a way as to allow them to be rotated out of the way during the binding process without disturbing the alignment of the clamped block of pages 36. Three heaters 38, 40 and 42 (FIG. 3) are positioned to heat the three adjacent surfaces to which binding strip 29 is to be applied (heater 38 is formed on the lower edge 39 of clamp 34). Each heater is regulated independently by a conventional microprocessor 44, allowing heat to be applied at the appropriate time and also controlling the temperature and pressure required to apply the binding strip 29 to the front and back edges and to the spine of the block of sheets 36 during the binding process. The use of heaters to heat and melt the adhesive to bind the book pages is conventional and is not, by itself, a part of the present invention and the use of microprocessor 44 to provide the signals to control the heaters 38, 40 and 42, the cutter 20 and other components are also well known and not part of the present invention.

Referring to FIG. 2, the process is initiated when the pages 36 are introduced into the binding cavity 25. These may be assembled outside the binding cavity 25 and introduced as a block of pages, the likely case if used manually to bind sheets into books. The sheets may also be introduced into the binding cavity individually until the complete set is accumulated; typically the case if apparatus 10 was integrated with a printer or copier producing sheets one at a time and delivering them to binding cavity 25. The edges of the sheets in binding cavity 25 are aligned either manually or by means of the clamps 32 and 34. After the complete set of sheets, including front and rear covers are assembled, the next step is to clamp the sheets together.

During the clamping step, the block of sheets 36 is positioned to align with the binding material roll 12 as shown in FIG. 3. The lower edge 39 of clamp 34 is rotated out of the way and the feed rollers 14 and 18 advance the binding roll 12 to the prescribed location along the front edge, or front cover, 15 of the block of sheet 36.

With the binding roll 12 in position along the lower edge of the front of the block of sheets 36, heater 38 is brought to bear against the binding sheet portion 27, applying heat and pressure to secure it to the front cover 15 as shown in FIG. 4.

After the leading edge of the binding sheet portion 29 is secured to the front cover 15 and while maintaining the integrity of the block pages 36, the block 36 is moved to the right as shown in FIG. 4, in the direction of arrow 35, drawing out a prescribed amount of sheet 29 proportional to the thickness of the block of pages while wrapping the sheet 29 around the spine portion 17 of the block 36. At the predetermined position, knife 20D is transported along the lateral width of the sheet 29 in the direction of arrow 80 severing it from roll 12.

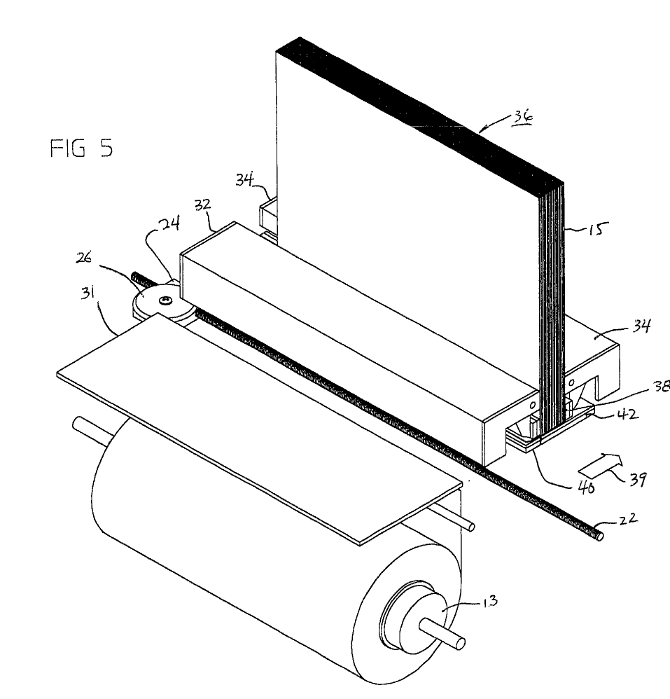

The block 36 and sheet portion 29 are transported further in the direction of arrow 39 and positioned over spine heater 40 as shown in FIG. 5. Heat and pressure are then applied to the spine portion 17 of the block of sheets 36 causing the sheets to be bonded together by the liquefied hot-melt glue on sheet portion 29. At this step, two of the three sides of block 36 are now adhered into position.

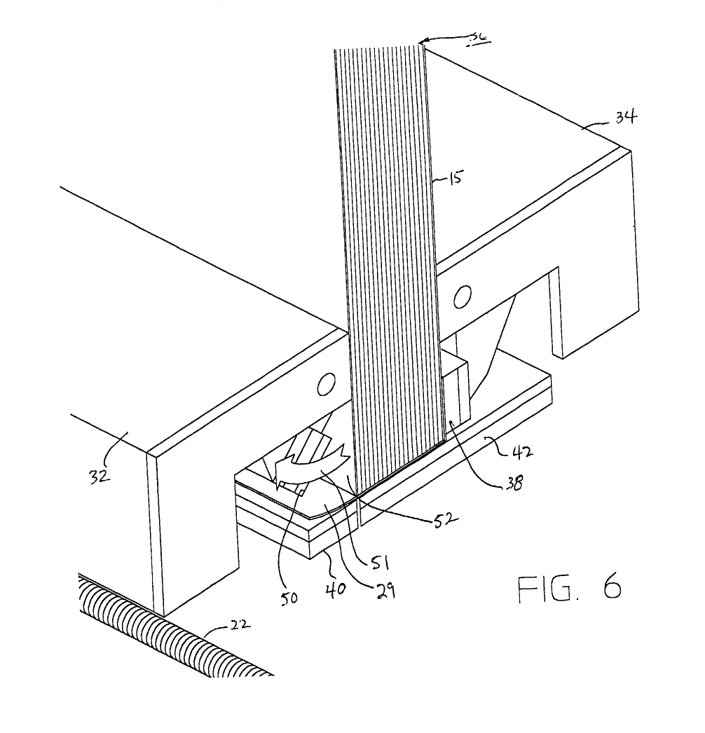

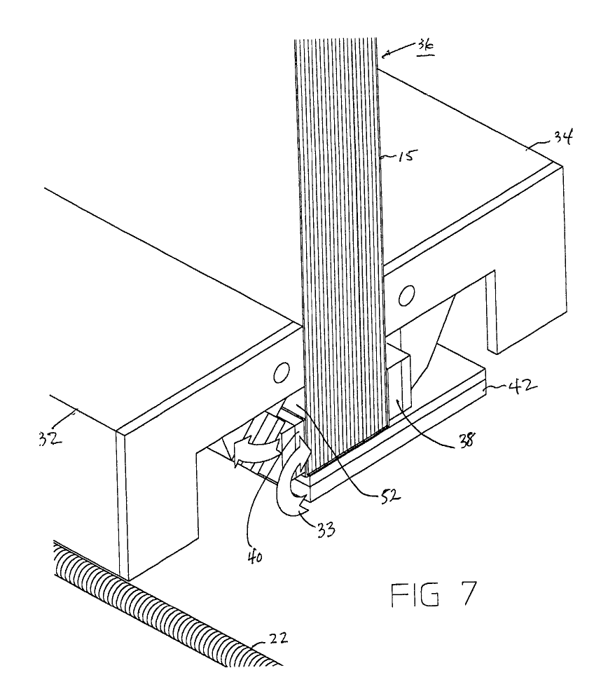

With the block of sheets 36 positioned to the right of the axis of rotation of heater 40, the lower edge 50 of clamp 32 is rotated out of the way in the direction of arrow 51 as shown in FIG. 6. Heater 40 is then rotated clockwise in the direction of arrow 53 wrapping the protruding portion of the binding strip portion 29 around the back cover 52 of the block of sheets 36 as shown in FIG. 7. Heat and pressure are again applied to secure the last portion of the strip portion 29. All three surfaces of the binding strip 29 are secured for a period of time sufficient to insure good binding results.

The bound document is then transported back to the original starting position over the paper shelf 31 (transport mechanism is not shown but is of a conventional design) in the direction of arrow 60 as shown in FIG. 2 and allowed to cool sufficiently.

After cooling, the clamps 32 and 34 are moved apart in the direction of arrow 62 and the finished bound document is removed from binding cavity and the process is ready to start over.

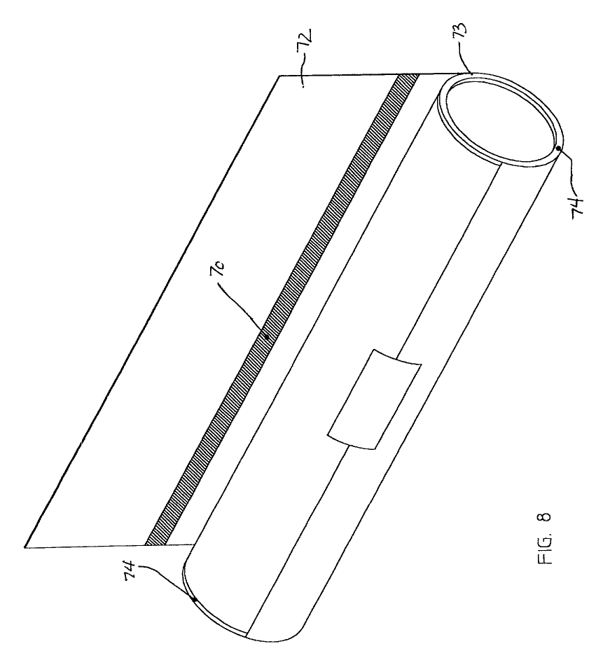

FIG. 8 illustrates a binding material roll 12 in accordance with the teachings of the present invention. Roll 12 includes a strip of resistive material 70 formed on the inner surface 72 of the roll near the tail end (the resistive strip 70 applied to the binding material is physically wrapped around the inner core 73 of the roll 12 as illustrated). Resistive strip 70 has a resistance value coded to correspond to the physical characteristics of the roll itself, i.e. the type of paper, the width of the roll, the heating levels required to melt the adhesive coating, etc. Sensors on the spindle 13 detect the resistance level and couple the information to microprocessor 44 which in turn controls the apparatus components.

When the material on the roll is consumed, the resistive strip 70 becomes disconnected from the conductive edges 74 of the core 73, exposing the conductive edges 74 on spindle 13. This condition is detected by sensors (not shown) which then generate a signal indicating that no further binding can take place until the roll is replaced, thus preventing partial or incomplete binding of the last block of pages. Microprocessor 44, in response to this signal, essentially turns the apparatus off. When the roll is replaced, microprocessor 44 turns the apparatus on.

The present invention thus provides a new and improved book binding method that is more automated and faster than book binding apparatus currently available.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method of making a book having a plurality of sheets and a front cover comprising a continuous roll of binding material positioned on a spindle member, one surface of the binding material being coated with a heat softened adhesive on one surface, the width of the material equal to the width of the sheets to be bound together comprising the steps of:
advancing the binding material into position adjacent said pages;
securing said binding material to the edge of said front cover of the block of sheets to be bound;
controlling the amount of binding tape withdrawn from said roll of binding material after being secured to the edge of said front cover so it is proportional to the thickness of the block of sheets to be bound; and
separating a portion of said binding material from the rest of the binding material roll after it has been secured to said front cover edge.

2. The method of claim 1 wherein a book cover and spine member portion are included as part of said book.

3. The method of claim 1 wherein said portion of said binding material is selectively heated on three surfaces to insure the appropriate binding conditions required to secure said front cover.

4. The method of claim 1 wherein said binding material has a coded resistive strip formed on said secured surface.

5. The method of claim 5 wherein said spindle member has a conductive member formed thereon.

6. The method of claim 6 further including the step of detecting said conductive member when the roll of said conductive member is substantially depleted from said spindle member.

7. Apparatus for making a book having a plurality of sheets and a front cover comprising a continuous roll of binding material positioned on a spindle member, one surface of the binding material being coated with a heat softened adhesive on one surface, the width of the material equal to the width of the sheets to be bound together comprising:
means for advancing the binding material into position adjacent said pages;
means for securing said binding material to the edge of said front cover of the block of sheets to be bound;
a microprocessor for controlling the amount of binding tape withdrawn from said roll of binding material after being secured to the edge of said front cover so it is proportional to the thickness of the block of sheets to be bound; and
a cutter for separating a portion of said binding material from the rest of the binding material roll after it has been secured to said front cover edge.

8. The apparatus of claim 7 wherein a book cover and spine member portion are included as part of said book.

9. The apparatus of claim 7 further including means for selectively heating said binding portion on three surfaces to insure the appropriate binding conditions required to secure said front cover, said spine member and said back cover.

10. The apparatus of claim 7 wherein said binding material has a coded resistive strip formed on said secured surface.

11. The apparatus of claim 7 wherein said spindle member has a conductive member formed thereon.

12. The method of claim 11 further including means for detecting said conductive member when the roll of said conductive member is substantially depleted from said spindle member.
